(19) United States
(12) Patent Application Publication
(10) Pub. No.: US 2015/0165822 A1
(43) Pub. Date: Jun. 18, 2015

(54) Pneumatic Tire

(71) Applicant: Kouichi Koutoku, Hiratsuka-shi (JP)

(72) Inventor: Kouichi Koutoku, Hiratsuka-shi (JP)

(73) Assignee: The Yokohama Rubber Co., LTD., Minato-ku, Tokyo (JP)

(21) Appl. No.: 14/404,316

(22) PCT Filed: Jul. 13, 2012
(86) PCT No.: PCT/JP2012/068027

§ 371 Date: Nov. 26, 2014

(51) Int. Cl. B60C 9/20; B60C 11/04; B60C 5/12; B60C 3/00

(52) U.S. Cl. CPC B60C 9/20; B60C 3/00; B60C 11/04; B60C 5/12

(57) ABSTRACT

A pneumatic tire comprises a carcass layer, a belt layer disposed on an outer side of the carcass layer in a tire radial direction, and a tread rubber disposed on the outer side of the belt layer in the tire radial direction. The belt layer is formed by laminating a pair of cross belts having a belt angle of not less than 10° and not more than 45° in absolute values and having belt angles of mutually opposite signs, and a circumferential reinforcing layer having a belt angle within a range of ±5° with respect to the tire circumferential direction. A tread width TW and a total tire width SW have a relationship such that 0.79≦TW/SW≦0.89.

### TECHNICAL FIELD

The present invention relates to a pneumatic tire, and more specifically, to a pneumatic tire having improved tire uneven wear resistance.

### BACKGROUND

Heavy duty tires with low aspects mounted singly on trucks and buses and the like demonstrate suppression of tire radial growth in the center region, demonstrate uniformity of contact pressure distribution in a tire width direction, and demonstrate improved tire uneven wear resistance due to the disposition of a circumferential reinforcing layer in a belt layer. The technology disclosed in Japanese Patent Nos. 4642760, 4663638 and 4663639 relates to conventional pneumatic tires that are configured in this manner.

### SUMMARY

The present invention provides a pneumatic tire having improved tire uneven wear resistance. The pneumatic tire according to the present invention comprises a carcass layer, a belt layer disposed on an outer side of the carcass layer in a tire radial direction, and a tread rubber disposed on the outer side of the belt layer in the tire radial direction. In such a pneumatic tire, the belt layer is formed by laminating a pair of cross belts having a belt angle of not less than 10° and not more than 45° in absolute values and having belt angles of mutually opposite signs, and a circumferential reinforcing layer having a belt angle within a range of ±5° with respect to a tire circumferential direction; and a tread width TW and a total tire width SW have a relationship such that 0.79≦TW/SW≦0.89, and a highest position diameter Ya of the carcass layer, a height position diameter Yb of the carcass layer at an end portion of the circumferential reinforcing layer, and a widest position diameter Yc of the carcass layer have relationships such that 0.80≦Yc/Ya≦0.90 and 0.95≦Yb/Ya≦1.00.

Also, the pneumatic tire according to the present invention comprises a carcass layer, a belt layer disposed on an outer side of the carcass layer in a tire radial direction, and a tread rubber disposed on an outer side of the belt layer in the tire radial direction. In such a pneumatic tire, the belt layer is formed by laminating a pair of cross belts having a belt angle of not less than 10° and not more than 45° in absolute values and having belt angles of mutually opposite signs, and a circumferential reinforcing layer having a belt angle within a range of ±5° with respect to the tire circumferential direction; and a tread width TW and a cross-sectional width Wca of the carcass layer have a relationship such that 0.82≦TW/Wca≦0.92, and a highest position diameter Ya of the carcass layer, a height position diameter Yb of the carcass layer at an end portion of the circumferential reinforcing layer, and a widest position diameter Yc of the carcass layer have relationships such that 0.80≦Yc/Ya≦0.90 and 0.95≦Yb/Ya≦1.00.

In the pneumatic tire according to the present invention, radial growth in a center region is suppressed due to the belt layer having the circumferential reinforcing layer. Moreover, radial growth in the left and right shoulder portions is suppressed due to the ratios TW/SW, Yc/Ya, and Yb/Ya being within the above ranges. Consequently, a difference in radial growths between the center region and a shoulder region is alleviated and the contact pressure distribution of the tire is made uniform. This has the advantage that the uneven wear resistance of the tire is increased.

Also, with the pneumatic tire according to the present invention, a difference in radial growths between the center region and the shoulder region is alleviated and the contact pressure distribution in the tire width direction is made uniform due to the ratio TW/Wca being within the above range. This has the advantage that the uneven wear resistance of the tire is increased.

### BRIEF DESCRIPTION OF THE DRAWINGS

FIG. 1 is a cross-sectional view in a tire meridian direction illustrating a pneumatic tire according to an embodiment of the present invention.

FIG. 2 is an explanatory view illustrating a belt layer of the pneumatic tire depicted in FIG. 1.

FIG. 3 is an explanatory view illustrating the belt layer of the pneumatic tire depicted in FIG. 1.

FIG. 4 is an explanatory view illustrating the effect of the pneumatic tire depicted in FIG. 1.

FIG. 5 is an explanatory view illustrating a modified example of the pneumatic tire depicted in FIG. 1.

FIG. 6 is an explanatory view illustrating a modified example of the pneumatic tire depicted in FIG. 1.

FIG. 7 is a table showing results of performance testing of pneumatic tires according to embodiments of the present invention.

FIG. 8 is a table showing results of performance testing of pneumatic tires according to embodiments of the present invention.

FIG. 9 is a table showing results of performance testing of pneumatic tires according to embodiments of the present invention.

FIG. 10 is an explanatory view illustrating a shoulder portion having a round shape.

### DETAILED DESCRIPTION

The present invention is described below in detail with reference to the drawings. However, the present invention is not limited to these embodiments. Moreover, constituents of the embodiment which can possibly or obviously be substituted while maintaining consistency with the present invention are included. Furthermore, the multiple modified examples described in the embodiment can be combined as desired within the scope apparent to a person skilled in the art.

### Pneumatic Tire

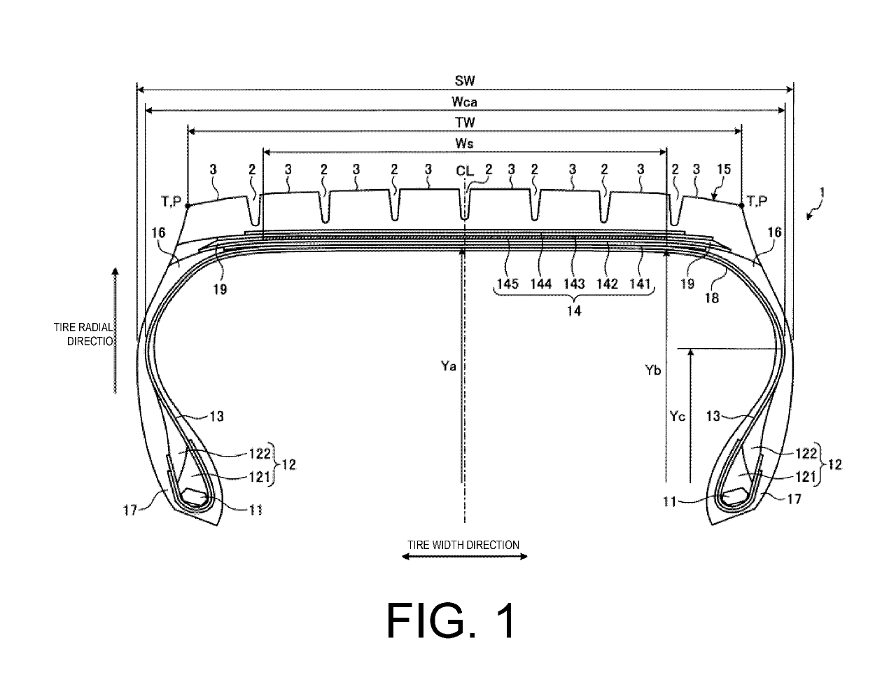

FIG. 1 is a cross-sectional view in a tire meridian direction illustrating a pneumatic tire according to an embodiment of the present invention. In this drawing, a radial tire for heavy loads that is mounted on trucks, buses, and the like for long-distance transport is illustrated as an example of the pneumatic tire 1. Note that the symbol CL refers to a tire equator plane. Moreover, a tread edge P and a tire ground contact edge T are in accord each other in FIG. 1. A circumferential reinforcing layer 145 in FIG. 1 is indicated by hatching.

The pneumatic tire 1 includes a pair of bead cores 11,11, a pair of bead fillers 12,12, a carcass layer 13, a belt layer 14, tread rubber 15, a pair of side wall rubbers 16,16, and a pair of rim cushion rubbers 17, 17 (see FIG. 1).

The pair of bead cores 11,11 have annular structures and constitute cores of left and right bead portions. The pair of bead fillers 12,12 are formed from a lower filler 121 and an upper filler 122, and are disposed on a periphery of each of the pair of bead cores 11,11 in a tire radial direction so as to reinforce the bead portions.

The carcass layer 13 stretches between the left and right side bead cores 11 and 11 in toroidal form, forming a framework for the tire. Additionally, both ends of the carcass layer 13 are folded from the inner side in the tire width direction toward the outer side in the tire width direction and fixed so as to wrap around the bead cores 11 and the bead fillers 12. Also, the carcass layer 13 is constituted by a plurality of carcass cords formed from steel or organic fibers (for example, nylon, polyester, rayon, or the like), covered by coating rubber, and subjected to a rolling process, having a carcass angle (the angle of inclination of the fiber direction of the carcass cords with respect to the tire circumferential direction) of not less than 85° and not more than 95° in absolute values.

The belt layer 14 is formed by laminating a plurality of belt plies 141 to 145, and disposing the belts to extend over an outer circumference of the carcass layer 13. A detailed configuration of the belt layer 14 is described below.

The tread rubber 15 is disposed on the periphery of the carcass layer 13 and the belt layer 14 in the tire radial direction, and forms a tire tread. The pair of side wall rubbers 16,16 is disposed on each outer side of the carcass layer 13 in the tire width direction, so as to form left and right side wall portions of the tire. The pair of rim cushion rubbers 17, 17 is respectively disposed on the outer side in the tire width direction of the left and right bead cores 11, 11 and bead fillers 12, 12, so as to form left and right bead portions.

In the configuration in FIG. 1, the pneumatic tire 1 includes seven circumferential main grooves 2 that extend in the tire circumferential direction, and eight land portions 3 partitioned and formed by the circumferential main grooves 2. The land portions 3 are formed of blocks that are segmented in the tire circumferential direction by ribs or lug grooves (not illustrated) that continue in the tire circumferential direction.

### Belt Layer

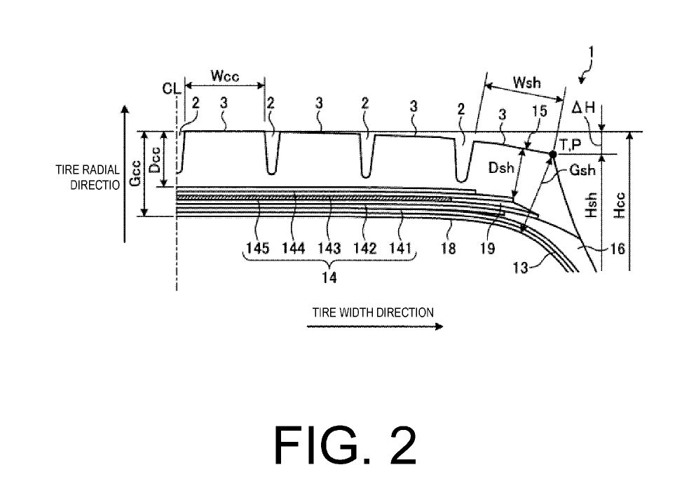

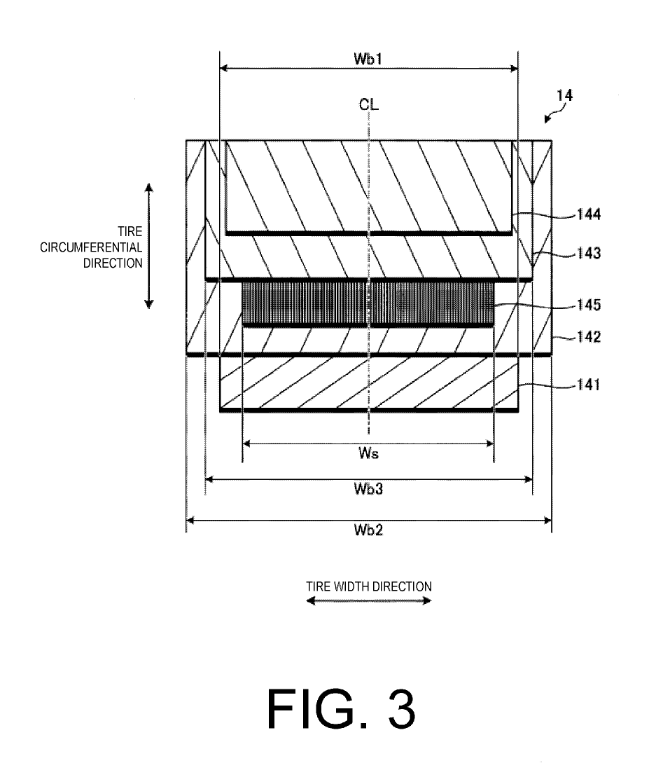

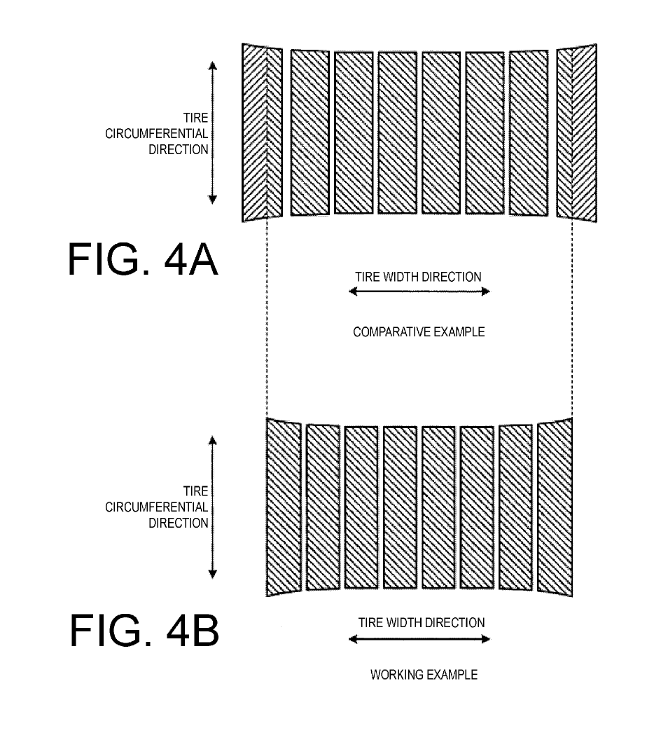

FIGS. 2 to 4 are explanatory views illustrating a belt layer of the pneumatic tire depicted in FIG. 1. In these drawings, FIG. 2 illustrates a region on one side of the tread portion demarcated by the tire equatorial plane CL, and FIGS. 3 and 4 illustrate a laminated structure of the belt layer 14. The circumferential reinforcing layer 145 and a belt edge cushion 19 in FIG. 2 are indicated by hatching. The thin lines in the belt plies 141 to 145 in FIG. 3 schematically represent the inclination of belt cords.

The belt layer 14 is formed by laminating a high angle belt 141, a pair of cross belts 142, 143, a belt cover 144, and a circumferential reinforcing layer 145, disposed on the periphery of the carcass layer 13 (see FIG. 2).

The high angle belt 141 is configured by a plurality of belt cords formed from steel or organic fibers, covered by coating rubber, and subjected to a rolling process, having a belt angle (angle of inclination of belt cord fiber direction with respect to the tire circumferential direction) of not less than 45° and not more than 70° in absolute values. Moreover, the high angle belt 141 is disposed so as to be laminated outward in the tire radial direction of the carcass layer 13.

The pair of cross belts 142, 143 are configured by a plurality of belt cords formed from steel or an organic fiber, covered by coating rubber, and subjected to a rolling process, having a belt angle of not less than 10° and not more than 45° in absolute values. Additionally, the pair of cross belts 142, 143 have belt angles that are of mutually opposite sign to each other, and are laminated so that the fiber directions of the belt cords intersect each other (a crossply structure). In the following description, the cross belt 142 positioned on the inner side in the tire radial direction is referred to as “inner-side cross belt”, and the cross belt 143 positioned on the outer side in the tire radial direction is referred to as “outer-side cross belt”. Three or more cross belts may be disposed so as to be laminated (not illustrated on the drawings). Moreover, the pair of cross belts 142, 143 are disposed so as to be laminated outward in the tire radial direction of the high angle belt 141.

Also, the belt cover 144 is configured by a plurality of belt cords formed from steel or organic fibers, covered by coating rubber, and subjected to a rolling process, having a belt angle of not less than 10° and not more than 45° in absolute values. Moreover, the belt cover 144 is disposed so as to be laminated outward in the tire radial direction of the cross belts 142, 143. In this embodiment, the belt cover 144 has the same belt angle as the outer-side cross belt 143, and is disposed in the outermost layer of the belt layer 14.

The circumferential reinforcing layer 145 is composed of rubber coated steel belt cords that are wound in a spiral manner with an inclination within a range of ±5° with respect to the tire circumferential direction. Additionally, the circumferential reinforcing layer 145 is disposed so as to be interposed between the pair of cross belts 142, 143. Additionally, the circumferential reinforcing layer 145 is disposed inward in the tire width direction of left and right edges of the pair of cross belts 142, 143. Specifically, one or a plurality of wires is wound spirally around the periphery of the inner-side cross belt 142, to form the circumferential reinforcing layer 145. This circumferential reinforcing layer 145 reinforces the stiffness in the tire circumferential direction. As a result, the tire durability is improved.

In the pneumatic tire 1, the belt layer 14 may have an edge cover (not illustrated on the drawings). Generally, the edge cover is constituted by a plurality of belt cords formed from steel or organic fibers, covered by coating rubber, and subjected to a rolling process, having a belt angle of not less than 0° and not greater than 5° in absolute values. Additionally, edge covers are disposed outward in the tire radial direction of the left and right edges of the outer-side cross belt 143 (or the inner-side cross belt 142). As a result of the band effect of the edge cover, the difference in radial growth of a tread center region and a shoulder region is reduced, and the uneven wear resistance performance of the tire is improved.

### Uneven Wear Suppression Structure

Heavy duty tires with low aspects mounted singly on trucks and buses and the like demonstrate suppression of tire radial growth in the center region, demonstrate uniformity of contact pressure distribution in the tire width direction, and demonstrate improved tire uneven wear resistance due to the disposition of a circumferential reinforcing layer in the belt layer.

Here, with the configuration having the circumferential reinforcing layer in the belt layer, radial growth of the tire in the center region (circumferential reinforcing layer disposition region) is suppressed while stiffness in the tire circumferential direction in the left and right shoulder regions (outside of circumferential reinforcing layer disposition region) is relatively reduced. As a result, there is a problem in that slippage of the tire ground contact patch is increased and uneven wear occurs in the left and right shoulder regions.

Accordingly, the pneumatic tire 1 employs the following configurations to improve tire uneven wear resistance (see FIGS. 1 to 3).

As illustrated in FIG. 1, in the pneumatic tire 1, a tread width TW and a total tire width SW have a relationship such that 0.79≦TW/SW≦0.89.

The tread width TW refers to a linear distance between the left and right tread edges P when the tire is assembled on a standard rim and provided with a prescribed internal pressure and is in an unloaded state.

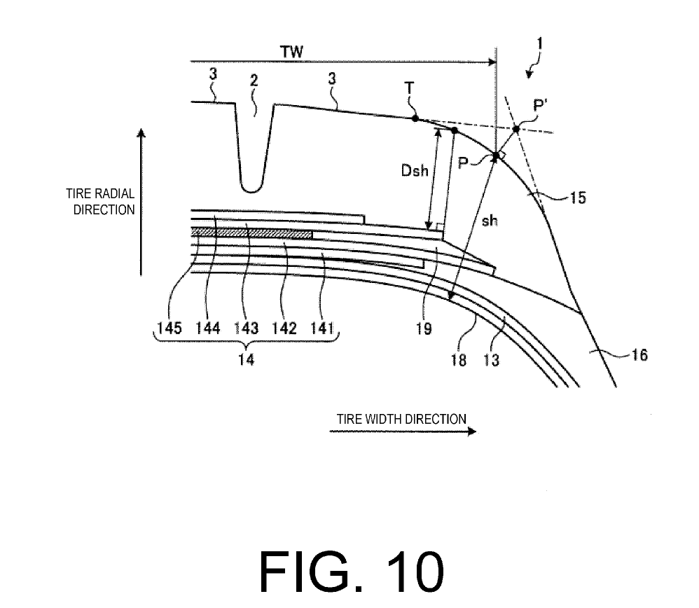

The tread edge P refers to a point of the tread edge portion in a configuration having a (1) square shaped shoulder portion. For example, in the configuration in FIG. 2, the tread edge P and a tire ground contact edge T are in accord with each other due to the shoulder portion having a square shape. Conversely, in a configuration (2) as illustrated in FIG. 10 where the shoulder portion has a round shape, an intersection P′ is taken from the tread portion profile and the side wall portion profile when viewed as a cross-section in the tire meridian direction, and the tread edge P is taken as the bottom of a perpendicular line drawn from the intersection P′ to the shoulder portion.

Note that the “tire ground contact edge T” refers to the maximum width position in a tire axial direction of a contact surface between the tire and a flat plate in a configuration in which the tire is assembled on a regular rim, filled to a prescribed internal pressure, placed perpendicularly with respect to the flat plate in a static state, and loaded with a load corresponding to a prescribed load.

The total tire width SW refers to a linear distance (including all portions such as letters and patterns on the tire surface) between the side walls when the tire is assembled on a standard rim and provided with a prescribed internal pressure and is in an unloaded state.

Herein, “standard rim” refers to a “standard rim” defined by the Japan Automobile Tyre Manufacturers Association (JATMA), a “design rim” defined by the Tire and Rim Association (TRA), or a “measuring rim” defined by the European Tyre and Rim Technical Organisation (ETRTO). “Regular inner pressure” refers to “maximum air pressure” stipulated by JATMA, a maximum value in “tire load limits at various cold inflation pressures” defined by TRA, and “inflation pressures” stipulated by ETRTO. Note that “regular load” refers to “maximum load capacity” stipulated by JATMA, a maximum value in “tire load limits at various cold inflation pressures” defined by TRA, and “load capacity” stipulated by ETRTO. However, with JATMA, in the case of passenger car tires, the regular internal pressure is an air pressure of 180 kPa, and the regular load is 88% of the maximum load capacity.

Moreover, a highest position diameter Ya of the carcass layer 13, a height position diameter Yb of the carcass layer 13 at the end portion of the circumferential reinforcing layer 145, and a widest position diameter Yc of the carcass layer 13 have the relationships of 0.80≦Yc/Ya≦0.90 and 0.95≦Yb/Ya≦1.00 (see FIG. 1)

The position diameters Ya of the carcass layer 13 are measured when the tire is assembled on a standard rim, inflated to a prescribed internal pressure, and no load is applied. The highest position diameter Ya of the carcass layer 13 is measured as a distance from the tire rotational axis to the intersection of the tire equatorial plane CL and the carcass layer 13. The height position diameter Yb of the carcass layer 13 at the end portion of the circumferential reinforcing layer 145 is measured as a distance from the tire rotational axis at the bottom of a perpendicular line drawn from the end portion of the circumferential reinforcing layer 145 to the carcass layer 13. The widest position diameter Yc of the carcass layer 13 is measured as a distance from the tire rotational axis to the widest position of the carcass layer 13.

Additionally, the tread width TW and a cross-sectional width Wca of the carcass layer 13 preferably have a relationship such that 0.82≦TW/Wca≦0.92 (see FIG. 1). As a result, the ratio TW/Wca is made appropriate.

The cross-sectional width Wca of the carcass layer 13 refers to a linear distance between the left and right maximum width positions of the carcass layer 13 when the tire is assembled on a standard rim and provided with a prescribed internal pressure and is in an unloaded state.

FIG. 4 is an explanatory view illustrating the effect of the pneumatic tire depicted in FIG. 1. A (a) Comparative Example and a (b) Working Example in FIG. 4 both show ground contact shapes of the pneumatic tire 1 having the circumferential reinforcing layer. However, in the Comparative Example in FIG. 4(a), the ratio TW/SW, the ratio Yc/Ya, the ratio Yb/Ya, and the ratio TW/Wca are outside of the above-mentioned ranges, while on the other hand, in the Working Example in FIG. 4(b), the ratio TW/SW, the ratio Yc/Ya, the ratio Yb/Ya, and the ratio TW/Wca are within the above-mentioned ranges.

Radial growth of the tire in the center region is suppressed due to the belt layer having the circumferential reinforcing layer in the configuration of FIG. 4(a). However, the radial growth in the left and right shoulder portions is large since the above ratios TW/SW, Yc/Ya, Yb/Ya, and TW/Wca are improper and thus the contact pressure distribution in the tire width direction is not uniform. Consequently, there is a possibility that uneven wear may occur in the left and right shoulder portions.

Conversely, with the configuration in FIG. 4(b), the circumferential reinforcing layer 145 suppresses the radial growth in the center region while the radial growth in the left and right shoulder portion is suppressed since the ratios TW/SW, Yc/Ya, Yb/Ya, TW/Wca are within the above-mentioned ratios. Consequently, a difference in radial growths between the center region and the shoulder region is alleviated and the tire contact pressure distribution is made uniform. Specifically, when comparing FIGS. 4(a) and 4(b), it can be seen that deformation when the tire makes ground contact is reduced with the configuration in FIG. 4(b). As a result, the uneven wear resistance of the tire is enhanced.

### Detailed Configuration of Belt Layer and Profile

As illustrated in FIG. 3, in the pneumatic tire 1, the circumferential reinforcing layer 145 is preferably disposed inward in the tire width direction from the left and right edges of the narrower cross belt 143 of the pair of cross belts 142, 143.

Also, as illustrated in FIG. 1, the width Ws of the circumferential reinforcing layer 145 is preferably within ranges such that 0.70≦Ws/TW≦0.90 with respect to the tread width TW. As a result, the ratio Ws/TW of the width Ws of the circumferential reinforcing layer 145 and the tread width TW is made appropriate.

The width Ws of the circumferential reinforcing layer 145 is measured when the tire is assembled on a standard rim, inflated to a prescribed internal pressure and is in an unloaded state. The width Ws of the circumferential reinforcing layer 145 is the distance between the outermost end portions of the divided portions when the circumferential reinforcing layer 145 has a structure that is divided in the tire width direction (not illustrated).

The cross-sectional width Wca of the carcass layer 13 is measured as a linear distance between the left and right maximum width positions of the carcass layer 13 when the tire is assembled on a standard rim and provided with a prescribed internal pressure and no load is applied.

Also, a width Wb2 of the wider cross belt 142 of the pair of cross belts 142, 143, and the cross-sectional width Wca of the carcass layer 13 preferably have a relationship such that 0.79≦Wb2/Wca≦0.89 (see FIGS. 1 and 2). As a result, the ratio Wb2/Wca is made appropriate.

The width Wb2 of the cross belt 142 is measured as distance in the tire width direction when the tire is assembled on a standard rim, inflated to a prescribed internal pressure, and no load is applied.

Additionally, a width Wb1 of the high angle belt 141 and a width Wb3 of the narrower cross belt 143 of the pair of cross belts 142, 143 preferably have a relationship such that 0.85≦Wb1/Wb3≦1.05 (see FIG. 3). As a result, the ratio Wb1/Wb3 is made appropriate.

The width Wb1 of the high angle belt 141 is measured as distance in the tire width direction when the tire is assembled on a standard rim, inflated to a prescribed internal pressure, and no load is applied.

In the configuration in FIG. 1, the belt layer 14 has a structure with left-right symmetry around the tire equatorial plane CL as illustrated in FIG. 3, and the width Wb1 of the high angle belt 141 and the width Wb3 of the narrower cross belt 143 have a relationship such that Wb1<Wb3. As a result, an edge portion of the high angle belt 141 is disposed on the inner side in the tire width direction than the edge portion of the narrower cross belt 143 in a region on either side of the tire equatorial plane CL. However, without being limited to this configuration, the width Wb1 of the high angle belt 141 and the width Wb3 of the narrower cross belt 143 may have a relationship such that Wb1≧Wb3 (not illustrated).

As illustrated in FIG. 2, a distance Gcc from the tread profile to the tire inner circumferential surface along the tire equatorial plane CL, and a distance Gsh from the tread edge P to the tire inner circumferential surface preferably have a relationship such that 0.85≦Gsh/Gcc≦1.10, or more preferably have a relationship such that 0.90≦Gsh/Gcc≦1.00. As a result, the relationship between the gauge (distance Gcc) at the tire equatorial plane CL and the gauge (distance Gsh) at the tread edge P is made appropriate.

The distance Gcc is measured as the distance from the intersection of the tire equatorial plane CL and the tread profile to the intersection of the tire equatorial plane CL and the tire inner circumferential surface when seen as a cross-section in the tire meridian direction. Therefore, in a configuration having a circumferential main groove 2 at the tire equatorial plane CL such as the configuration in FIG. 1 and FIG. 2, the distance Gcc is measured omitting the circumferential main groove 2. The distance Gsh is measured as the length of a perpendicular line from the tread edge P to the tire inner circumferential surface when seen as a cross-section in the tire meridian direction.

In the configuration in FIG. 2, the pneumatic tire 1 includes an innerliner 18 on the inner circumferential surface of the carcass layer 13, and the innerliner 18 is disposed across the entire region of the tire inner circumferential surface. In such a configuration, the distance Gcc and the distance Gsh are measured on the basis of the outer surface of the innerliner 18 (tire inner circumferential surface).

Moreover, a tread gauge Dcc at the tire equatorial plane CL, and a tread gauge Dsh at the edge portion of the cross belt 143 that is on the outer side of the pair of cross belts 142, 143 in the tire radial direction preferably have a relationship such that 0.90≦Dsh/Dcc≦1.10 (see FIG. 2). As a result, the relationship of the tread gauge (distance Dcc) at the tire equatorial plane CL and the tread gauge (distance Dsh) at the edge portion of the cross belt 143 on the outer side in the tire radial direction is made appropriate.

The tread gauge Dcc at the tire equatorial plane CL is measured as a distance from the tread profile to the outermost belt ply (belt cover 144) of the belt layer 14. The tread gauge Dcc is a central value of the thickness of the tread rubber 15 in the center region. When a circumferential main groove 2 is located at the measurement point, the tread gauge Dcc is measured excluding the circumferential main groove 2.

The tread gauge Dsh at the edge portion of the cross belt 143 is measured as a distance from the tread profile to the narrower cross belt 143. The tread gauge Dsh is a central value of the thickness of the tread rubber 15 in the shoulder region. When a circumferential main groove 2 is located at the measurement point, the tread gauge Dsh is measured excluding the circumferential main groove 2.

As illustrated in FIG. 10, in the configuration in which the edge portion of the cross belt 143 is on the outer side in the tire width direction than the tire ground contact edge T, the tread gauge Dsh is measured by drawing a line perpendicular to the cross belt 143 from the edge of the cross belt 143 to the tread surface and then measuring the length of the line.

Moreover, an outer diameter Hcc of the tread profile at the tire equatorial plane CL and an outer diameter Hsh of the tread profile at the tire ground contact edge T preferably have a relationship such that 0.010≦(Hcc−Hsh)/Hcc≦0.015 (see FIG. 2). As a result, a shoulder rounding amount ΔH (=Hcc−Hsh) in the shoulder region is made appropriate.

The outer diameters Hcc, Hsh of the tread profile are measured when the tire is assembled on a standard rim, inflated to a prescribed internal pressure, and no load is applied. Also, the “tire ground contact edge T” refers to the maximum width position in a tire axial direction of a contact surface between the tire and a flat plate in a configuration in which the tire is assembled on a regular rim, filled to a prescribed internal pressure, placed perpendicularly with respect to the flat plate in a static state, and loaded with a load corresponding to a prescribed load.

Additionally, hardness of the tread rubber 15 is preferably not less than 60 (see FIG. 1). As a result, stiffness of the tread rubber 15 is secured. The hardness of the tread rubber 15 has no upper limit in particular, but is restricted due to the relationship with tire functionality.

Here, “rubber hardness” refers to JIS-A hardness in accordance with JIS-K6263.

Moreover, a ground contact width Wcc of the land portion 3 closest to the tire equatorial plane CL and a ground contact width Wsh of the land portion 3 on the outermost side in the tire width direction preferably have a relationship such that 0.90≦Wsh/Wcc≦1.20 (see FIG. 2). As a result, the ground contact width Wcc of the land portion 3 at the center region and the ground contact width Wsh of the land portion 3 at the shoulder region are made uniform.

The ground contact widths Wcc, Wsh are measured when the tire is assembled on a standard rim, inflated to a prescribed internal pressure, and no load is applied.

Moreover, belt cords of the high angle belt 141 are preferably steel wire, and the high angle belt preferably has not less than 15 ends/50 mm and not more than 25 ends/50 mm (see FIG. 4). Moreover, belt cords of the pair of cross belts 142, 143 are preferably steel wire, and the pair of cross belts 142, 143 preferably has not less than 18 ends/50 mm and not more than 28 ends/50 mm. Also, the belt cords that constitute the circumferential reinforcing layer 145 are steel wire, and the circumferential reinforcing layer 145 preferably has not less than 17 ends/50 mm and not more than 30 ends/50 mm. As a result, the strengths of the belt plies 141, 142, 143, 145 are properly secured.

Elongation is preferably not less than 1.0% and not more than 2.5% when the tensile load of the belt cords as components that configure the circumferential reinforcing layer 145 is 100 N to 300 N, and is preferably not less than 0.5% and not more than 2.0% when the tensile load is 500 N to 1000 N as a tire (when removed from the tire). The belt cords (high elongation steel wire) have good elongation when a low load is applied compared with normal steel wire, so they can withstand the loads that are applied to the circumferential reinforcing layer 145 during the time from manufacture until the tire is used, so it is possible to suppress damage to the circumferential reinforcing layer 145, which is desirable.

The elongation of the belt cord is measured in accordance with JIS G3510.

Additionally, the width Wb3 of the narrower cross belt 143 and the width Ws of the circumferential direction reinforcing layer 145 preferably have a relationship such that 0.75≦Ws/Wb≦0.90. As a result, the width Ws of the circumferential direction reinforcing layer 145 can be properly secured.

### Chamfered Portion of Shoulder Land Portion

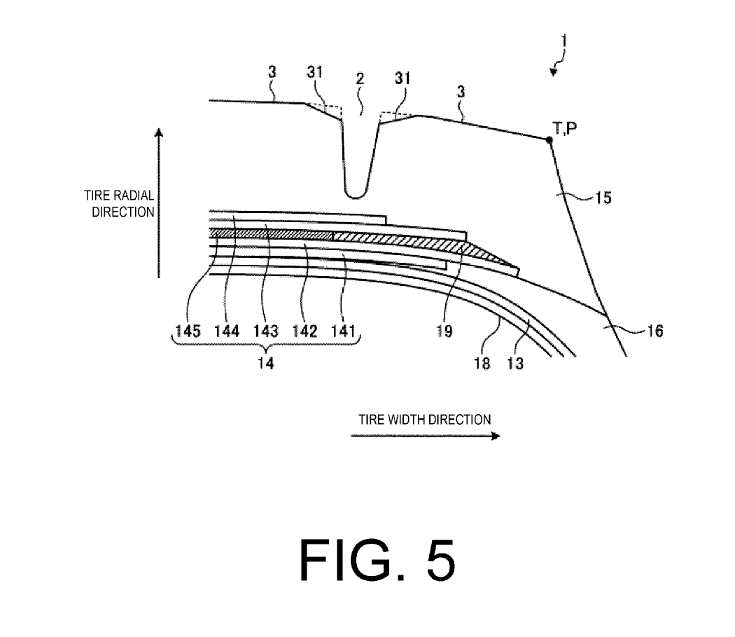

FIG. 5 is an explanatory view of a modified example of the pneumatic tire depicted in FIG. 1. FIG. 5 illustrates an enlarged cross-section of the shoulder land portion.

As illustrated in FIG. 5, the land portions 3 on the outermost side in the tire width direction preferably have a chamfered portion 31 at an edge portion on the circumferential main groove 2 sides in the pneumatic tire 1. The chamfered portions 31 may be corner chamfering or round chamfering that is formed continuously in the tire circumferential direction along the circumferential main grooves 2, or may be notches that are formed discontinuously in the tire circumferential direction.

For example, in the configuration in FIG. 5, the left and right land portions 3, 3 partitioned by the outermost circumferential main groove 2 are ribs and both have chamfered portions 31 on the edge portions of the outermost circumferential main groove 2 sides. The chamfered portions 31 are corner chamfers and are formed continuously in the tire circumferential direction.

### Belt Edge Cushion Two-Color Structure

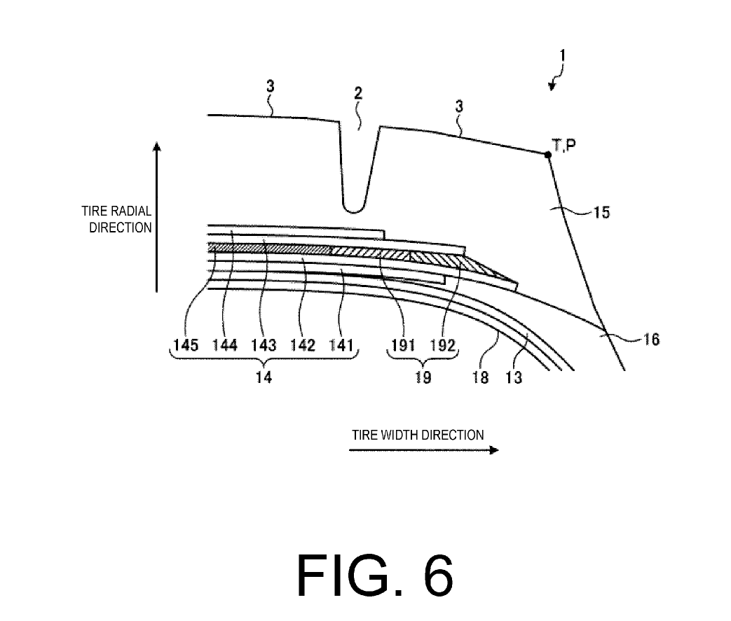

FIG. 6 is an explanatory view of a modified example of the pneumatic tire depicted in FIG. 1. FIG. 6 is an enlarged view of an end portion of the belt layer 14 on the outer side in the tire width direction. The circumferential reinforcing layer 145 and the belt edge cushion 19 in FIG. 6 are indicated by hatching.

In the configuration in FIG. 1, the circumferential reinforcing layer 145 is disposed inward in the tire width direction of the left and right edges of the narrower cross belt 143 of the pair of cross belts 142, 143. The belt edge cushion 19 is sandwiched between the pair of cross belts 142, 143 and disposed at a position corresponding to the edge portion of the pair of cross belts 142, 143. Specifically, the belt edge cushion 19 is disposed on the outer side of the circumferential reinforcing layer 145 in the tire width direction and flanking the circumferential reinforcing layer 145, and extends from the end portion on the outer side of the circumferential reinforcing layer 145 in the tire width direction to the end portion on the outer side of the pair of cross belts 142, 143 in the tire width direction.

In the configuration in FIG. 1, the belt edge cushion 19 has a structure that is thicker as a whole than the circumferential reinforcing layer 145 due to the thickness increasing toward the outer side in the tire width direction. The belt edge cushion 19 has a modulus E at 100% elongation that is lower than the coating rubber of the cross belts 142, 143. Specifically, the modulus E at 100% elongation of the belt edge cushion 19 and a modulus Eco of the coating rubber have a relationship such that 0.60≦E/Eco≦0.95. As a result, there is an advantage that the occurrence of separation between rubber materials in a region to the outer side in the tire width direction of the pair of cross belts 142, 143 and the circumferential reinforcing layer 145 is suppressed.

Conversely, according to the configuration in FIG. 6, the belt edge cushion 19 in the configuration in FIG. 1 has a two-color structure composed of a stress relief rubber 191 and an edge portion relief rubber 192. The stress relief rubber 191 is disposed between the pair of cross belts 142, 143 and flanks the circumferential reinforcing layer 145 on the outer side of the circumferential reinforcing layer 145 in the tire width direction. The edge portion relief rubber 192 is disposed between the pair of cross belts 142, 143 and at a position on the outer side of the stress relief rubber 191 in the tire width direction and corresponding to the edge portion of the pair of cross belts 142, 143. Therefore, the belt edge cushion 19 has a structure composed by disposing the stress relief rubber 191 and the edge portion relief rubber 192 side to side in the tire width direction to fill a region from the end portion of the circumferential reinforcing layer 145 on the outer side in the tire width direction to the edge portion of the pair of cross belts 142, 143.

Moreover, a modulus Ein at 100% elongation of the stress relief rubber 191 and the modulus Eco at 100% elongation of the coating rubber of the cross belts 142, 143 have a relationship such that Ein<Eco in the configuration in FIG. 6. Specifically, the modulus Ein of the stress relief rubber 191 and the modulus Eco of the coating rubber preferably have a relationship such that 0.6≦Ein/Eco≦0.9. Additionally, the modulus Ein at 100% elongation of the stress relief rubber 191 preferably is within ranges such that 4.0 MPa≦Ein≦5.5 MPa.

Moreover, a modulus Eout at 100% elongation of the edge portion relief rubber 192 and the modulus Ein at 100% elongation of the stress relief rubber 191 have a relationship such that Eout<Ein in the configuration in FIG. 6.

Since the stress relief rubber 191 is disposed on the outer side of the circumferential reinforcing layer 145 in the tire width direction in the configuration in FIG. 6, shearing strain of the periphery rubbers between the edge portion of the circumferential reinforcing layer 145 and the cross belts 142, 143 is alleviated. Moreover, since the edge portion relief rubber 192 is disposed at a position corresponding to the edge portions of the cross belts 142, 143, shearing strain of the peripheral rubbers at the edge portions of the cross belts 142, 143 is alleviated. Accordingly, separation of the peripheral rubber of the circumferential reinforcing layer 145 is suppressed.

### Effect

As described above, the pneumatic tire 1 includes the carcass layer 13, the belt layer 14 disposed on the outer side of the carcass layer 13 in the tire radial direction, and the tread rubber 15 disposed on the outer side of the belt layer 14 in the tire radial direction (see FIG. 1). Moreover, the belt layer 14 is formed by laminating the pair of cross belts 142, 143 having a belt angle of not less than 10° and not more than 45° in absolute values and having belt angles of mutually opposite signs, and the circumferential reinforcing layer 145 having a belt angle within a range of ±5° with respect to the tire circumferential direction (see FIG. 3). Moreover, the tread width TW and the total tire width SW have a relationship such that 0.79≦TW/SW≦0.89 (see FIG. 1). Moreover, the highest position diameter Ya of the carcass layer 13, the height position diameter Yb of the carcass layer 13 at the edge portion of the circumferential reinforcing layer 145, and the widest position diameter Yc of the carcass layer 13 have the relationships such that 0.80≦Yc/Ya≦0.90 and 0.95≦Yb/Ya≦1.00.

In such a configuration, radial growth of the tire in the center region is suppressed due to the belt layer 14 having the circumferential reinforcing layer 145. Moreover, radial growth of the left and right shoulder portions is suppressed due to the ratios TW/SW, Yc/Ya, and Yb/Ya being within the above ranges. Consequently, the difference in radial growths between the center region and a shoulder region is alleviated and the contact pressure distribution of the tire is made uniform (see FIG. 4(b)). This has the advantage that the uneven wear resistance of the tire is increased. Specifically, an average ground contact pressure is reduced due to the ratio TW/SW being equal to or greater than 0.79. Moreover, rising of the shoulder portion is suppressed and deformation when the tire makes ground contact is suppressed due to the ratio TW/SW being less than or equal to 0.89. Further, the tire shape is accurately maintained due to the ratio Yc/Ya being less than or equal to 0.90. The amount of shoulder rounding in the shoulder region is made appropriate due to the ratio Yb/Ya being equal to or greater than 0.95. The tread gauge at the edge portions of the cross belt 143 is made appropriate and the amount of shoulder rounding in the shoulder region is made appropriate due to the ratio Yb/Ya being less than or equal to 1.00.

Additionally, in the pneumatic tire 1, the tread width TW and the cross-sectional width Wca of the carcass layer 13 have a relationship such that 0.82≦TW/Wca≦0.92 (see FIG. 1). In such a configuration, the difference in radial growths between the center region and the shoulder region is alleviated (see FIG. 4(b)) and the contact pressure distribution in the tire width direction is made uniform due to the ratio TW/Wca being within the above range. This has the advantage that the uneven wear resistance of the tire is increased. Specifically, an average ground contact pressure is reduced due to the ratio TW/Wca being equal to or greater than 0.82. Moreover, rising of the shoulder portion is suppressed, and deformation when the tire makes ground contact is suppressed due to the ratio TW/Wca being less than or equal to 0.92.

In the pneumatic tire 1, the width Ws of the circumferential reinforcing layer 145 is within ranges such that 0.70≦Ws/TW≦0.90 with respect to the tread width TW (see FIG. 1). As a result, there is an advantage that the ratio Ws/TW of the width Ws of the circumferential reinforcing layer 145 and the tread width TW is made appropriate. Specifically, the contact pressure distribution of the tire is made uniform and the uneven wear resistance of the tire is increased due to the ratio Ws/TW being equal to or greater than 0.70. Moreover, fatigue rupture of the belt cords at the edge portions of the circumferential reinforcing layer 145 is suppressed due to the ratio Ws/TW being less than or equal to 0.90.

In the pneumatic tire 1, the width Wb3 of the narrower cross belt 143 and the width Ws of the circumferential reinforcing layer 145 are within ranges such that 0.75≦Ws/Wb3≦0.90 (see FIG. 3). As a result, there is an advantage that the effect of suppressing radial growth in the center region is properly secured due to the circumferential reinforcing layer 145 and due to width Ws of the circumferential reinforcing layer 145 being properly secured.

In the pneumatic tire 1, the width Wb2 of the wider cross belt 142 of the pair of cross belts 142, 143, and the cross-sectional width Wca of the carcass layer 13 have a relationship such that 0.79≦Wb2/Wca≦0.89 (see FIGS. 1 and 3). With the above configuration, there is an advantage that tire durability is improved due to the ratio Wb2/Wca being within the above range. Specifically, there is an advantage that tire uneven wear resistance is improved and tire radial growth in the shoulder region is suppressed due to the ratio Wb2/Wca being equal to or greater than 0.79. Also, fatigue rupture of the belt cords at the edge portions of the wider cross belt 142 is suppressed due to the ratio Wb2/Wca being less than or equal to 0.89.

In the pneumatic tire 1, the belt layer 14 includes the high angle belt 141 having a belt angle of not less than 45° and not more than 70° in absolute values. Moreover, the pair of cross belts 142, 143 are disposed on the outer side in the tire radial direction of the high angle belt 141, and the circumferential reinforcing layer 145 is disposed in between the pair of cross belts 142, 143 (see FIG. 3), on the inner side in the tire radial direction of the pair of cross belts 142, 143, or on the inner side in the tire radial direction of the high angle belt 141 (not illustrated). Moreover, the high angle belt 141 and the cross belt 142 that is on the inner side in the tire radial direction of the pair of cross belts 142, 143 have belt angles with the same sign (see FIG. 3). By applying this pneumatic tire 1 having such a configuration, there is an advantage that a noticeable effect in tire uneven wear resistance improvement is achieved.

Additionally, in the pneumatic tire 1, the width Wb1 of the high angle belt 141 and the width Wb3 of the narrower cross belt 143 of the pair of cross belts 142, 143 have a relationship such that 0.85≦Wb1/Wb3≦1.05. With the above configuration, there is an advantage that the ratio Wb1/Wb3 between the width Wb1 of the high angle belt 141 and the width Wb3 of the narrower cross belt 143 is made appropriate and tire uneven wear resistance is improved.

In the pneumatic tire 1, the distance Gcc from the tread profile to the tire inner circumferential surface along the tire equatorial plane CL, and the distance Gsh from the tread edge P to the tire inner circumferential surface have a relationship such that 0.85≦Gsh/Gcc≦1.10 (see FIG. 2). In such a configuration, the relationship between the gauge (distance Gcc) at the tire equatorial plane CL and the gauge (distance Gsh) at the tread edge P is made appropriate. As a result, there is an advantage that the contact pressure distribution of the tire is made uniform and the uneven wear resistance of the tire is increased.

Moreover, in the pneumatic tire 1, the tread gauge Dcc (distance from the tread profile to the outermost belt ply (belt cover 144) of the belt layer 14 in FIG. 2) at the tire equatorial plane CL, and the tread gauge Dsh (distance from the tread profile to the narrower cross belt 143 in FIG. 2) at the edge portion of the cross belt 143 that is on the outer side of the pair of cross belts 142, 143 in the tire radial direction have a relationship such that 0.90≦Dsh/Dcc≦1.10 (see FIG. 2). With such a configuration, the relationship of the tread gauge (distance Dcc) at the tire equatorial plane CL and the tread gauge (distance Dsh) at the edge portions of the cross belt 143 on the outer side in the tire radial direction is made appropriate. As a result, there is an advantage that the contact pressure distribution of the tire is made uniform and the uneven wear resistance of the tire is increased.

Moreover, in the pneumatic tire 1, the outer diameter Hcc of the tread profile at the tire equatorial plane CL and the outer diameter Hsh of the tread profile at the tire ground contact edge T have a relationship such that 0.010≦(Hcc−Hsh)/Hcc≦0.015 (see FIG. 2). As a result, there is an advantage that the amount of shoulder rounding ΔH (=Hcc−Hsh) in the shoulder region is made appropriate and tire uneven wear resistance is improved. Specifically, an increase in the contact length of the shoulder region is suppressed and early wear in the shoulder land portion 3 is suppressed due to the ratio (Hss−Hsh)/Hcc being equal to or greater than 0.010. Moreover, the amount of shoulder rounding AH in the shoulder region is reduced and the uneven wear of the shoulder land portion is suppressed due to the ratio (Hcc-Hsh)/Hcc being less than or equal to 0.015.

Additionally, hardness of the tread rubber 15 in the pneumatic tire 1 is not less than 60 (see FIG. 1). As a result, there is an advantage that stiffness of the tread rubber 15 is secured.

Additionally, the pneumatic tire 1 includes a plurality of circumferential main grooves 2 extending in the tire circumferential direction and a plurality of land portions 3 partitioned and formed by the circumferential main grooves 2 (see FIG. 1). Moreover, the ground contact width Wcc of the land portion 3 closest to the tire equatorial plane CL and the ground contact width Wsh of the land portion 3 on the outermost side in the tire width direction have a relationship such that 0.90≦Wsh/Wcc≦1.20. With such a configuration, the ground contact width Wcc of the land portion 3 at the center region and the ground contact width Wsh of the land portion 3 at the shoulder region are made uniform. As a result, there is an advantage that the contact pressure distribution in the tire width direction is made appropriate and uneven wear resistance performance of the tire is improved.

Moreover, in the pneumatic tire 1, the land portions 3 on the outermost side in the tire width direction have chamfered portions 31 at edge portions of the circumferential main groove 2 sides (see FIG. 5). As a result, there is an advantage that rib edge ground contact pressure on the circumferential main groove 2 side in the shoulder land portion is reduced and uneven wear resistance is improved.

Also, in the pneumatic tire 1, the belt cords that constitute the circumferential reinforcing layer 145 is steel wire, and the circumferential reinforcing layer 145 has not less than 17 ends/50 mm and not more than 30 ends/50 mm. As a result, there is an advantage that the effect of suppressing radial growth in the center region is properly secured due to the circumferential reinforcing layer 145.

In the pneumatic tire 1, elongation is not less than 1.0% and not more than 2.5% when the tensile load of the belt cords as components that configure the circumferential reinforcing layer 145 is 100 N to 300 N. As a result, there is an advantage that the effect of suppressing radial growth in the center region is properly secured due to the circumferential reinforcing layer 145.

In the pneumatic tire 1, elongation is not less than 0.5% and not more than 2.0% when the tensile load of the belt cords as components that constitute the circumferential reinforcing layer 145 is 500 N to 1000 N. As a result, there is an advantage that the effect of suppressing radial growth in the center region is properly secured due to the circumferential reinforcing layer 145.

In the pneumatic tire 1, the circumferential reinforcing layer 145 is disposed inward in the tire width direction of the left and right edges of the narrower cross belt 143 of the pair of cross belts 142, 143 (see FIG. 3). The pneumatic tire 1 includes the stress relief rubber 191 disposed between the pair of cross belts 142, 143 and on the outer side of the circumferential reinforcing layer 145 in the tire width direction and flanking the circumferential reinforcing layer 145, and the edge portion relief rubber 192 disposed between the pair of cross belts 142, 143 and at a position on the outer side of the stress relief rubber 191 in the tire width direction and corresponding to the edge portion of one of the pair of cross belts 142, 143 (see FIG. 6).

In such a configuration, there is an advantage that fatigue rupture of the periphery rubber at the edge portion of the circumferential reinforcing layer 145 is suppressed due to the circumferential reinforcing layer 145 being disposed on the inner side in the tire width direction of the left and right edge portions of the narrower cross belt 143 of the pair of cross belts 142, 143. Since the stress relief rubber 191 is disposed on the outer side of the circumferential reinforcing layer 145 in the tire width direction, shearing strain of the periphery rubber between the edge portion of the circumferential reinforcing layer 145 and the cross belts 142, 143 is alleviated. Moreover, since the edge portion relief rubber 192 is disposed at a position corresponding to the edge portions of the cross belts 142, 143, shearing strain of the peripheral rubbers at the edge portions of the cross belts 142, 143 is alleviated. Accordingly, there is an advantage that separation of the periphery rubber of the circumferential reinforcing layer 145 is suppressed.

In the pneumatic tire 1, the modulus Ein at 100% elongation of the stress relief rubber 191 and the modulus Eco at 100% elongation of the coating rubber of the pair of cross belts 142, 143 have a relationship such that Ein<Eco (see FIG. 6). As a result, there is an advantage that the modulus Ein of the stress relief rubber 191 is made appropriate and the shearing strain of the periphery rubber between the edge portion of the circumferential reinforcing layer 145 and the cross belts 142, 143 is alleviated.

In the pneumatic tire 1, the modulus Ein at 100% elongation of the stress relief rubber 191 and the modulus Eco at 100% elongation of the coating rubber of the pair of cross belts 142, 143 have a relationship such that 0.6≦Ein/Eco≦0.9 (see FIG. 6). As a result, there is an advantage that the modulus Ein of the stress relief rubber 191 is made appropriate and the shearing strain of the periphery rubber between the edge portion of the circumferential reinforcing layer 145 and the cross belts 142, 143 is alleviated.

Additionally, in the pneumatic tire 1, the modulus Ein at 100% elongation of the stress relief rubber 191 is within ranges such that 4.0 MPa≦Ein≦5.5 MPa (see FIG. 6). As a result, there is an advantage that the modulus Ein of the stress relief rubber 191 is made appropriate and the shearing strain of the periphery rubber between the edge portion of the circumferential reinforcing layer 145 and the cross belts 142, 143 is alleviated.

### Target of Application

The pneumatic tire 1 is preferably applied to a heavy duty tire with an aspect ratio of not less than 40% and not more than 55% when assembled on a standard rim, inflated with the prescribed internal pressure and the standard load is applied. A heavy duty tire has a higher load under use than a passenger tire. Thus, a radial difference occurs easily between the region where the circumferential reinforcing layer is disposed and the regions on the outer side of the circumferential reinforcing layer in the tire width direction. Moreover, a ground contact shape having an hourglass shape occurs easily in the tire having the above-mentioned low aspect ratio. Accordingly, a noticeable effect in suppressing the above-mentioned uneven wear is achieved by applying the pneumatic tire 1 to such a heavy duty tire.

### Examples

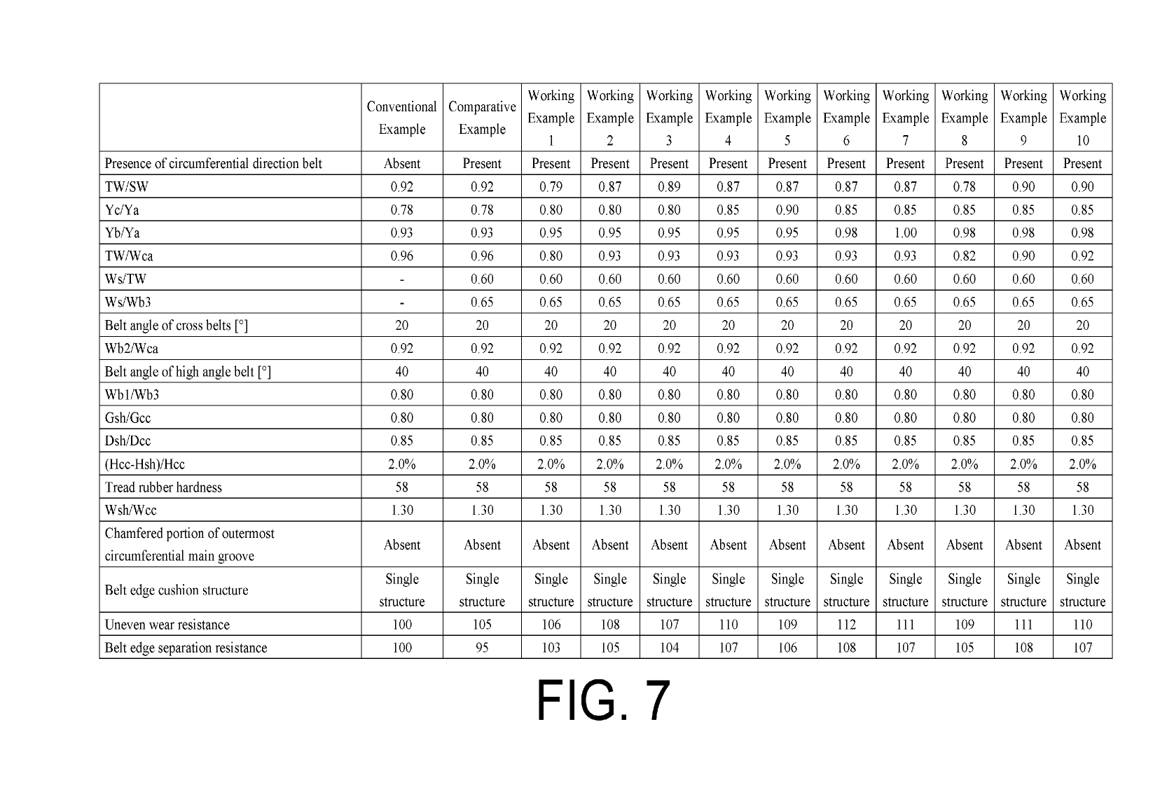

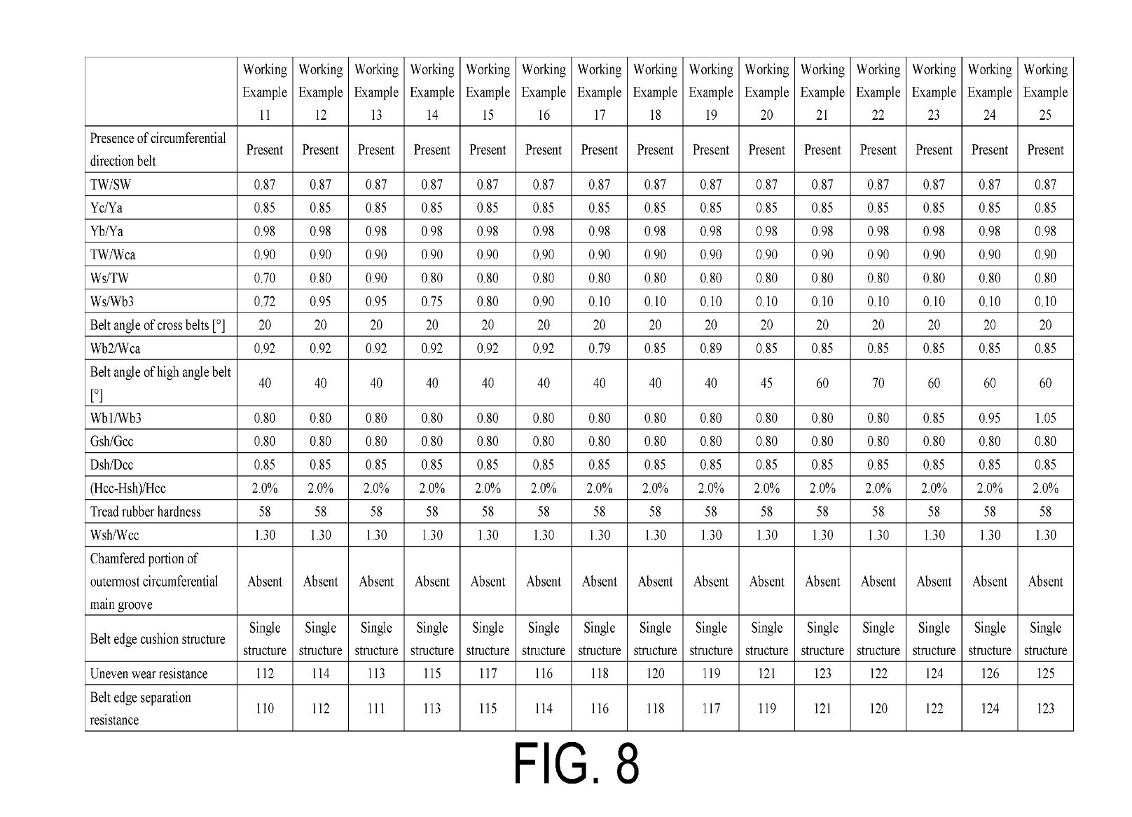

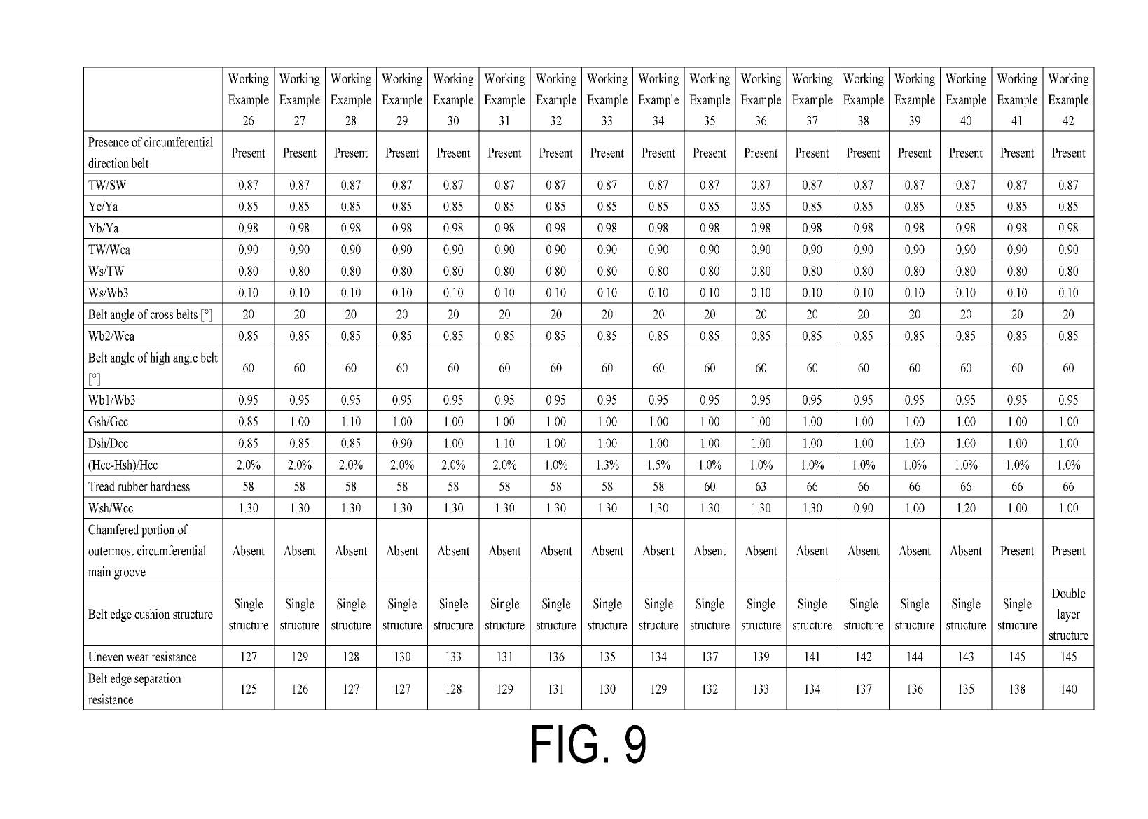

FIGS. 7 to 9 are tables showing results of performance testing of pneumatic tires according to embodiments of the present invention.

Evaluations of (1) uneven wear resistance and (2) belt-edge separation resistance of a plurality of mutually different pneumatic tires were conducted for the performance tests (see FIGS. 7 to 9). Pneumatic tires having a tire size of 445/50R22.5 were assembled on a TRA specification standard rim (rim size 22.5×14.0) and provided with a TRA specification maximum air pressure of (830 kPa) and a maximum load of 45.37 kN.

(1) The pneumatic tires were mounted on a trailer axis of 6×4 tractor and trailer as a test vehicle for the evaluation related to uneven wear resistance. After driving the test vehicle for 100,000 km, the amount of wear at the edge portion of the shoulder land portion and the amount of wear of the outermost circumferential main groove were measured and the differences were calculated as an amount of shoulder rounding wear for performing the evaluation. Results of the evaluations were indexed and the index value of the pneumatic tire of Conventional Example was set as the standard score (100). Higher scores were preferable. 105 or more in the evaluations indicate superiority over the Conventional Examples, and 110 or more demonstrate a sufficient effect.

(2) Evaluations concerning belt edge separation resistance were conducted by low pressure durability testing using an indoor drum testing machine. The travel speed was set to 45 km/h and the load was gradually increased from 45.37 kN by 5% (2.27 kN) every 12 hours to measure the travel distance until the tire ruptured. Index scoring against a conventional standard score of 100 was conducted based on the measurement results. In these evaluations, higher scores were preferable. 105 or more in the evaluations indicate superiority over the Conventional Examples, and 110 or more demonstrate a sufficient effect.

The pneumatic tires 1 of Working Examples 1 to 41 had the configuration depicted in FIGS. 1 to 3. Further, the total tire width SW was SW=446 mm. Moreover, the modulus at 100% elongation of the coating rubber of all the belt layers 14 was 6.0 MPa.

The pneumatic tire 1 of Working Example 42 was a modified example of the configuration depicted in FIGS. 1 to 3 and had the configuration described in FIG. 6. The modulus Ein at 100% elongation of the stress relief rubber 191 was Ein=4.8 MPa.

In the configuration of FIGS. 1 to 3, the pneumatic tire of the Conventional Example does not have the circumferential reinforcing layer. The pneumatic tire of Comparative Example had the configuration depicted in FIGS. 1 to 3.

As is clear from the test results, with the pneumatic tires 1 of Working Examples 1 to 42, uneven wear resistance performance of the tires is enhanced.

What is claimed is:

1. A pneumatic tire comprising a carcass layer, a belt layer disposed outward in a tire radial direction of the carcass layer, and a tread rubber disposed outward in the tire radial direction of the belt layer, wherein
the belt layer is formed by laminating a pair of cross belts having a belt angle of not less than 10° and not more than 45° in absolute values and having belt angles of mutually opposite signs, and a circumferential reinforcing layer having a belt angle within a range of ±5° with respect to the tire circumferential direction,
a tread width TW and a total tire width SW have a relationship such that 0.79≦TW/SW≦0.89, and
a highest position diameter Ya of the carcass layer, a height position diameter Yb of the carcass layer at an end portion of the circumferential reinforcing layer, and a widest position diameter Yc of the carcass layer have relationships such that 0.80≦Yc/Ya≦0.90 and 0.95≦Yb/Ya≦1.00.

2. A pneumatic tire comprising a carcass layer, a belt layer disposed outward in a tire radial direction of the carcass layer, and a tread rubber disposed outward in the tire radial direction of the belt layer, wherein
the belt layer is formed by laminating a pair of cross belts having a belt angle of not less than 10° and not more than 45° in absolute values and having belt angles of mutually opposite signs, and a circumferential reinforcing layer having a belt angle within a range of ±5° with respect to the tire circumferential direction,
a tread width TW and a cross-sectional width Wca of the carcass layer have a relationship such that 0.82≦TW/Wca≦0.92, and
a highest position diameter Ya of the carcass layer, a height position diameter Yb of the carcass layer at an end portion of the circumferential reinforcing layer, and a widest position diameter Yc of the carcass layer have relationships such that 0.80≦Yc/Ya≦0.90 and 0.95≦Yb/Ya≦1.00.

3. The pneumatic tire according to claim 1, wherein a width Ws of the circumferential reinforcing layer is in ranges such that 0.70≦Ws/TW≦0.90 with respect to the tread width TW.

4. The pneumatic tire according to claim 1, wherein the circumferential reinforcing layer is disposed inward in a tire width direction of left and right edges of a narrower cross belt of the pair of cross belts, and
a width Wb3 of the narrower cross belt and the width Ws of the circumferential reinforcing layer are in ranges such that 0.75≦Ws/Wb3.

5. The pneumatic tire according to claim 1, wherein a width Wb2 of a wider cross belt of the pair of cross belts, and the cross-sectional width Wca of the carcass layer have a relationship such that 0.79≦Wb2/Wca≦0.89.

6. The pneumatic tire according to claim 1, wherein the belt layer includes a high angle belt having a belt angle of not less than 45° and not more than 70° in absolute values,
the pair of cross belts are disposed on the outer side in the tire radial direction of the high angle belt, and
the circumferential reinforcing layer is disposed on the outer side in the tire radial direction of the pair of cross belts, in between the pair of cross belts, on the inner side in the tire radial direction of the pair of cross belts, or on the inner side in the tire radial direction of the high angle belt, and
the belt angle of the cross belt on the inner side in the tire radial direction of the pair of cross belts, and the belt angle of the high angle belt have the same sign.

7. The pneumatic tire according to claim 6, wherein a width Wb1 of the high angle belt and the width Wb3 of the narrower cross belt of the pair of cross belts have a relationship such that 0.85≦Wb1/Wb3≦1.05.

8. The pneumatic tire according to claim 1, wherein a distance Gcc from a tread profile to a tire inner circumferential surface along a tire equatorial plane, and a distance Gsh from a tread edge to the tire inner circumferential surface have a relationship such that 0.85≦Gsh/Gcc≦1.10.

9. The pneumatic tire according to claim 1, wherein a tread gauge Dcc at the tire equatorial plane, and a tread gauge Dsh at the edge portion of the cross belt that is on the outer side of the pair of cross belts in the tire radial direction have a relationship such that 0.90≦Dsh/Dcc≦1.10.

10. The pneumatic tire according to claim 1, wherein an outer diameter Hcc of the tread profile at the tire equatorial plane and an outer diameter Hsh of the tread profile at the tire ground contact edge have a relationship such that 0.010≦(Hcc−Hsh)/Hcc≦0.015.

11. The pneumatic tire according to claim 1, wherein a hardness of the tread rubber is not less than 60.

12. The pneumatic tire according to claim 1 further comprising: a plurality of circumferential main grooves extending in the tire circumferential direction and a plurality of land portions partitioned and formed by the circumferential main grooves, wherein
a ground contact width Wcc of the land portion closest to the tire equatorial plane and a ground contact width Wsh of the land portion on an outermost side in the tire width direction have a relationship such that 0.90≦Wsh/Wcc≦1.20.

13. The pneumatic tire according to claim 12, wherein the land portions on the outermost side in the tire width direction have chamfered portions at edge portions of the circumferential main groove sides.

14. The pneumatic tire according to claim 1, wherein belt cords of the circumferential reinforcing layer are steel wire and have a number of ends of not less than 17 ends/50 mm and not more than 30 ends/50 mm.

15. The pneumatic tire according to claim 1, wherein elongation is not less than 1.0% and not more than 2.5% when a tensile load of belt cords as components that configure the circumferential reinforcing layer is 100 N to 300 N.

16. The pneumatic tire according to claim 1, wherein elongation is not less than 0.5% and not more than 2.0% when a tensile load of belt cords as cured tire components that constitute the circumferential reinforcing layer is 500 N to 1000 N.

17. The pneumatic tire according to claim 1, wherein the circumferential reinforcing layer is disposed inward in the tire width direction of left and right edges of the narrower cross belt of the pair of cross belts, the pneumatic tire further comprising:
a stress relief rubber disposed between the pair of cross belts and disposed outward in the tire width direction of the circumferential reinforcing layer to flank the circumferential reinforcing layer; and
an edge portion relief rubber disposed between the pair of cross belts and disposed outward in the tire width direction of the stress relief rubber and in a position corresponding to an edge portion of the pair of cross belts to flank the stress relief rubber.

18. The pneumatic tire according to claim 17, wherein a modulus Ein at 100% elongation of the stress relief rubber and a modulus Eco at 100% elongation of coating rubber of the pair of cross belts have a relationship such that Ein<Eco.

19. The pneumatic tire according to claim 17 or 18, wherein the modulus Ein at 100% elongation of the stress relief rubber and the modulus Eco at 100% elongation of coating rubber of the pair of cross belts have a relationship such that 0.6≦Ein/Eco≦0.9.

20. The pneumatic tire according to claim 17, wherein the modulus Ein at 100% elongation of the stress relief rubber is in ranges such that 4.0 MPa≦Ein≦5.5 MPa.

21. The pneumatic tire according to claim 1 applied to a heavy duty tire with an aspect ratio of 55% or less.
